(19) United States
(12) Patent Application Publication
(10) Pub. No.: US 2003/0139827 A1
(43) Pub. Date: Jul. 24, 2003

(54) Determining economic effects of hypothetical tax policy changes

(76) Inventor: Geoffrey D. Phelps, Watertown, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/349,147

(22) Filed: Jan. 21, 2003

Related U.S. Application Data
(60) Provisional application No. 60/349,599, filed on Jan. 18, 2002.
(60) Provisional application No. 60/441,250, filed on Jan. 16, 2003.

(51) Int. Cl. G05B 13/02

(52) U.S. Cl. 700/36

(57) ABSTRACT

The disclosed technology can enable policy analysts, policy makers, economic administrators, and other interested parties to model, compare, and/or otherwise evaluate and analyze tax policies to ascertain the economic effects of such tax policies. The disclosed technology can further organize the presentation of data associated with such tax policies in one or more hierarchical policy trees, which can facilitate the configuration and analysis of the tax policies under investigation.

### RELATED APPLICATIONS

This claims priority to and the benefit of U.S. Provisional Patent Application No. 60/349,599, filed Jan. 18, 2002, and U.S. Provisional Patent Application No. not yet assigned, identified by Attorney Docket No. CRO-101.61, entitled “Tax Policy Analysis Manual (TPAS)”, and filed Jan. 16, 2003, both of which are incorporated herein by reference in their entirety.

### TECHNICAL FIELD

The disclosed technology relates generally to modeling software and more particularly to modeling software capable of determining economic effects of hypothetical tax policy changes.

### BACKGROUND

Revenue authorities, such as federal, state, and local governmental entities, are interested in formulating tax policies that generate sufficient income with which to purchase goods and provide services for their constituents, while concurrently avoiding unanticipated and undesirable behavior and side effects that can adversely affect their associated economies. For example, a state tax on electronic commerce transactions can result in a significant increase in revenue, but may also inadvertently reduce the number of jobs in that jurisdiction. Similarly, an increase in a state's capital gains tax rate may increase revenue at the expense of reducing business capital and increasing the tax burden of particular income tax filers. Changes in tax policy can also affect the investment and operation strategies of individuals, businesses, and/or other non-governmental entities. Accordingly, revenue authorities, taxable entities, industry groups, academics, researchers, consultants, and/or other entities are interested in technologies that can determine the economic effects of tax policy changes so as to pre-emptively and substantively evaluate tax change proposals.

### SUMMARY

The disclosed technology can enable policy analysts, policy makers, economic administrators, and other interested parties to model, compare, and/or otherwise evaluate and analyze tax policies to ascertain the economic effects of such tax policies. The disclosed technology can further organize the presentation of data associated with such tax policies in one or more hierarchical policy trees, which can facilitate the configuration, computation, and analysis of the tax policies under investigation.

In one embodiment, the disclosed technology provides methods and systems that can determine economic effects of one or more tax policies. Tax policies can be at least partially defined by one or more tax types (e.g., individual tax, business tax, property tax, sales tax, etc.), logical calculation groups (e.g., dividend tax, business profits tax, business enterprise tax, commercial property tax, residential owner-occupied tax, residential non-owner occupied tax, consumption tax, etc.), and/or computational elements (e.g., a reference to a database entry, a constant used to compute a parameter, a bracket to identify a range of values, a reference to a data structure, a mathematical expression, etc.).

A tax type, logical calculation group, and computational element can be associated and/or organized to provide a hierarchical tree associated with a first tax policy (e.g., corresponding to, for example, a proposed tax law change). One or more attributes associated with the tax type, logical calculation group, and/or computational elements can be selected and/or modified to at least partially define the first tax policy. The tax type, logical calculation group, and/or computational element can also be displayed at particular levels of the hierarchical tree in a user interface, such as a graphical user interface. In one embodiment, a selected logical calculation group can be displayed in a level of the hierarchical tree that is lower than the level of the hierarchical tree displaying a selected tax type and the display of the selected logical calculation group can be made in response to a selection of the tax type. Similarly, a selected computational element can be displayed in a level of the hierarchical tree that is lower than the level of the hierarchical tree displaying the selected logical calculation group and the display of the selected computational element can be made in response to the selection of the logical calculation group.

Data associated with the computational element in the hierarchical tree can be compared to data associated with a corresponding computational element of a second tax policy (e.g., corresponding to, for example, a current tax law). The compared data can serve, at least partially, as the basis for computing at least one economic effect (e.g., a change in a macroeconomic variable) of the first tax policy.

### BRIEF DESCRIPTION OF THE DRAWINGS

The foregoing discussion will be understood more readily from the following detailed description of the disclosed technology, when taken in conjunction with the accompanying drawings in which:

FIG. 1 schematically illustrates an exemplary infrastructure suitable for supporting a simulation and analysis of a tax policy change;

FIG. 2A illustrates an exemplary display of a graphical user interface that can facilitate a definition of a tax policy;

FIG. 2B illustrates an exemplary display of a graphical user interface that can facilitate a definition of a simulation associated with a tax policy;

FIG. 2C illustrates an exemplary display of a graphical user interface that can facilitate a definition of a report and/or display output data associated with a simulation of a tax policy;

FIG. 2D illustrates an exemplary display of a graphical user interface that can facilitate a definition of an economic forecast and/or display forecast output data associated with a simulation of a tax policy;

FIG. 3 illustrates an exemplary methodology that can be performed by one or more software application programs and/or associated processes when simulating/analyzing a tax policy;

FIGS. 4A-4E illustrate exemplary displays of a graphical user interface that can facilitate a definition of an exemplary tax policy;

FIGS. 4F-4G illustrate exemplary displays of a graphical user interface that can facilitate a definition of an exemplary simulation of the tax policy of FIGS. 4A-4E; and

FIGS. 5A-5I illustrate exemplary reports that can include at least some of the output data generated by the simulation defined in FIGS. 4F-4G.

### DETAILED DESCRIPTION

Unless otherwise specified, the illustrated embodiments can be understood as providing exemplary features of varying detail of certain embodiments, and therefore, unless otherwise specified, features, components, processes, modules, data elements, and/or aspects of the illustrations can be otherwise combined, interconnected, sequenced, separated, interchanged, and/or rearranged without departing from the disclosed systems or methods. Additionally, the shapes, sizes, and orientations of components are also exemplary and unless otherwise specified, can be altered without affecting the disclosed technology.

Policy makers such as executives, legislators, and other top decision-makers that set forth governing rules and regulations are aware that their decisions may have widespread effects that are not readily ascertainable. For example, changes in a tax policy may adversely affect corporate investment in a jurisdiction, changes in a healthcare policy may adversely affect the price and/or availability of pharmaceutical products, changes in a homeland security policy may adversely affect interstate commerce, changes in an immigration policy may adversely affect a company's access to a skilled labor pool, changes in an international trade policy may inadvertently reduce the availability of spare parts, etc.

The disclosed technology can enable policy makers and/or other interested parties to model the behavior and complex interactions present in their jurisdictions, organizations, etc. so that the effects of changes to their policies can be anticipated in advance of their implementation. In this manner, modifications to proposed policy changes can be evaluated prior to their adoption and thus mitigate, if not eradicate, the unwanted side-effects of the initial proposed policy change. Similarly, proposed policy changes can be modified to further enhance desirable effects of a policy. Although the disclosed technology can be applied to substantially any type of policy, the description provided below focuses primarily on applications related to state tax policies so as to maintain a reasonable clarity and brevity of such description, rather than survey applications of the disclosed technology to the myriad of other policy types that can be supported. It is believed that those skilled in the art will be able to readily apply the capabilities of the disclosed technology as applied to tax policies to substantially any other type of policy.

The disclosed technology can be used to forecast the economic effects of policy changes to one or more tax types including, for example, individual tax (e.g., income, interest and dividend, and personal taxes), sales tax (e.g., transaction, excise, and consumer taxes), property tax (e.g., commercial, residential owner-occupied, residential non-owner occupied property taxes), and business tax (e.g., business profits tax). The economic forecasts can be based on a variety of simulation types in which, for example, future economic assumptions are presumed to be unaffected by a tax computation under consideration (static tax, static economics), macro-economic models can be executed for a default economic forecast (static tax, dynamic economics), and/or potential economic effects of tax policy changes are computed and used to update existing economic forecasts that can be subsequently used to compute future year taxes (dynamic tax, dynamic economics).

The effects of tax policy changes can also be examined for one or more industry sectors (and/or sub-sectors), such as a) agricultural, forestry, fishing; b) mining; c) construction; d) owner-occupied dwellings; e) finance, insurance, real estate; f) manufacturing; g) retail trade; h) services; i) transportation; and/or j) wholesale trade. The economic effects of such tax policy changes can be represented as a change in one or more macroeconomic variables, such as a percentage change in i) an economic output of a state, ii) household consumption, iii) investment in capital stock, iv) investment in real property, v) government expenditures, vi) interstate and international exports; vii) interstate and international imports, viii) consumer price index, ix) number of employed people, x) after tax wage rate, xi) after tax wage income, xii) after tax rate of return on capital stock, xiii) after tax rate of return on buildings and structures, xiv) value of structures and land, and/or xv) value of capital stock.

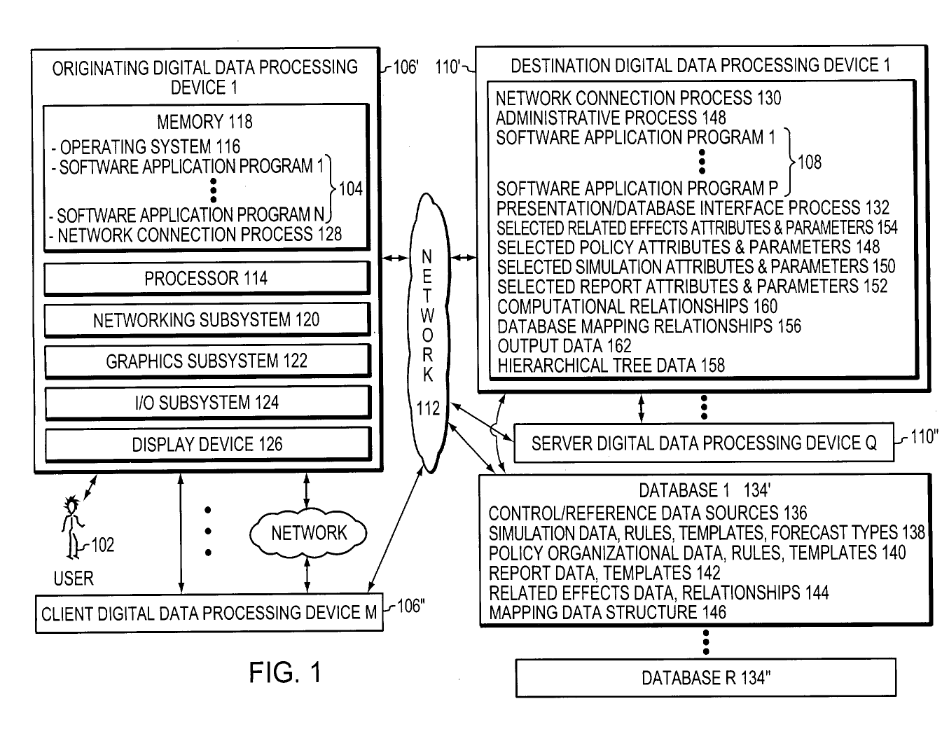

In brief overview and with reference to FIG. 1, a policy maker, policy analyst, and/or any other type of authorized user 102 or entity desiring to determine the economic effects of a tax policy change can execute one or more software application programs 104 (e.g., a web browser or any other type of application program capable of providing an interface to a tax policy analysis/simulation application program) residing on one or more originating digital data processing devices 106 to generate messages that are routed to, or receive messages generated by, one or more software application programs 108 (e.g., tax policy analysis/simulation application programs) of corresponding destination digital data processing devices 110 via a data communications network 112. A message is defined broadly to refer to one or more data packets that can include control information (such as addresses of the originating and destination digital data processing devices 106, 110, names/identifiers of the software application programs 104, 108, etc) and payload data that can include, for example, data relevant to an analysis/simulation of a tax policy. Although the functionality of the software application programs 104, 108 are described herein as being executed in a distributed fashion (e.g., various functions performed on the networked originating and destination digital data processing devices 106, 110), those skilled in the art will recognize that at least some, if not all, of the functionality of the software application programs 104, 108 can be executed within a single digital data processing device or executed within other additional digital data processing devices that may be connected by any type of digital data path (e.g., point-to-point, networked, data bus, etc.).

A digital data processing device 106, 110 can be a personal computer, computer workstation (e.g., Sun, HP), laptop computer, server computer, mainframe computer, handheld device (e.g., personal digital assistant, Pocket PC, cellular telephone, etc.), information appliance, or any other type of generic or special-purpose, processor-controlled device capable of receiving, processing, and/or transmitting digital data. A processor 114 refers to the logic circuitry that responds to and processes instructions (not shown) that drive digital data processing devices and can include, without limitation, a central processing unit, an arithmetic logic unit, an application specific integrated circuit, a task engine, and/or any combinations, arrangements, or multiples thereof. To reduce the complexity of FIG. 1, the processor 114, operating system 116, and any other subsystems 118-126 that may be present in a digital data processing device are shown as residing in the originating digital data processing device 106. Those skilled in the art will recognize that a processor, operating system, and all or at least some of the subsystems 118-126 may also be present in the destination digital data processing device 110.

The instructions executed by a processor 114 represent, at a low level, a sequence of “0's” and “1's” that describe one or more physical operations of a digital data processing device. These instructions can be pre-loaded into a programmable memory (not shown) (e.g., EEPROM) that is accessible to the processor 114 and/or can be dynamically loaded into/from one or more volatile (e.g., RAM, cache, etc.) and/or non-volatile (e.g., hard drive, etc.) memory elements communicatively coupled to the processor 114. The instructions can, for example, correspond to the initialization of hardware within a digital data processing device 106, 110, an operating system 116 that enables the hardware elements to communicate under software control and enables other computer programs to communicate, and/or software application programs 104, 108 that are designed to perform particular functions for an entity or other computer programs, such as functions relating to the simulation/analysis of tax policies and/or forecasting of economic effects of such policies. The operating system 116 can support either single-threading or multi-threading, where a thread refers to an independent stream of execution running in a multi-tasking environment. A single-threaded system is capable of executing one thread at a time. In contrast, a multi-threaded system is capable of supporting multiple concurrently executing threads and can thus perform multiple tasks simultaneously.

A local user 102 can interact with a digital data processing device 106 by, for example, viewing a command line, graphical, and/or other user interface and entering commands via an input device, such as a mouse, keyboard, touch sensitive screen, track ball, keypad, etc. The user interface can be generated by a graphics subsystem 122 of a digital data processing device 106, which renders the interface into an on or off-screen surface (e.g., on a display device 126 and/or in a video memory). Inputs from the user 102 can be received via an input/output subsystem 124 and routed to a processor 114 via an internal bus (not shown) (e.g., system bus) for execution under the control of the operating system 116.

Similarly, a remote user (not shown) can interact with a digital data processing device 106, 110 over a data communications network 112. The inputs from the remote user can be received and processed in whole or in part by a remote digital data processing device (not shown) collocated with the remote user. Alternatively or in combination, the inputs can be transmitted back to and processed by the local digital data processing device 106 or to another digital data processing device via one or more networks using, for example, thin client technology. The user interface of the local digital data processing device 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices typically require a networking subsystem 120 (e.g., as embodied in a network interface card) to establish the communications link between the devices. The communications link interconnecting digital data processing devices can include elements of a data communications network, a point to point connection, a bus, and/or any other type of digital data path capable of conveying processor-readable data.

A data communications network 112 can comprise a series of network nodes (e.g., the originating and destination digital data processing devices 106, 110) that can be interconnected by network devices and communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a destination node regardless of any dissimilarities in the network topology (e.g., bus, star, token ring), spatial distance (local, metropolitan, or wide area network), transmission technology (e.g., TCP/IP, Systems Network Architecture), data type (e.g., data, voice, video, or multimedia), nature of connection (e.g., switched, non-switched, dial-up, dedicated, or virtual), and/or physical link (e.g., optical fiber, coaxial cable, twisted pair, wireless, etc.) between the originating and destination network nodes.

A process generally refers to the execution of instructions that interact with operating parameters, message data/parameters, network connection parameters/data, variables, constants, software libraries, and/or any other elements needed for the proper execution of the instructions, within an execution environment in a memory of a digital data processing device, that causes a processor to control the operations of the data processing device in accordance with the desired functionality of an operating system, software application program, and/or any other type of generic or specific-purpose application program (or subparts thereof). For example, a network connection process 128, 130 can refer to a set of instructions and other appropriate elements that enable a digital data processing device 106, 110 to establish a communication link and communicate with other digital data processing devices during one or more sessions. A session refers to a series of transactions communicated between two network nodes during the span of a single network connection, where the session begins when the network connection is established and terminates when the connection is ended.

A software application program 108 that can include one or more software processes (e.g., a calculation process/engine) executing within a memory of the destination digital data processing device 110 can include a set of instructions and/or other appropriate elements that enable the digital data processing device 110 to process policy, simulation, report, and related economic effects data into information that can be used by a policy maker to evaluate the anticipated effects of a tax policy change. The software application program 108 can interact with a presentation/database interface process 132 to support the processing of the aforementioned data.

A presentation/database interface process 132 can refer to a set of instructions and other appropriate elements that enable a digital data processing device 110 to access one or more databases 134 (e.g., a database based on the Microsoft SQL database produced by the Microsoft Corporation of Redmond, Wash.) and/or other types of data repositories to obtain access to, for example, control/reference data sources 136; simulation data, rules templates, and forecasts 138; policy organizational data, rules, and templates 140; report data and templates 142; related economic effects data and relationships 144; and/or mapping data structures 146. The accessed information can then be provided to the software application program 108 for further processing and manipulation.

Control/reference data sources 136 can include known tax records, estimated tax records, demographic data, and/or other types of data associated with one or more taxed entities (e.g., person, business, etc.). An exemplary set of control/reference data sources 136 can include, for example, tables and/or other data structures that provide information on filing status options (e.g., single, married-filing jointly, married-filing separately, surviving widower with dependent child, etc.), veterans status options (e.g., Vietnam era veteran, Korean conflict veteran, etc.), exemption status options (e.g., no exemptions, over 65 years old, over 65 years old and blind, blind, etc.), tenure codes (e.g., vacant, owned with a mortgage, owned free and clear of a mortgage, rented for cash rent, etc.), and/or residency coverage (full year resident/non-resident, part year resident/non-resident, resident commuter, etc.).

Simulation data, rules, templates, and/or forecast types 138 can include, for example, a) data corresponding to one or more existing tax policies (e.g., a baseline policy corresponding to a current tax law/policy) that can be copied, edited, and/or otherwise manipulated in the definition of and/or comparison with a proposed tax policy of interest; b) a set of weights that can be applied to individual, business, property, and/or sales taxes to enable the simulation of future years performance; c) a set of pre-configured economic forecasts and/or macroeconomic relationships (e.g., related economic effects data and relationships 144) that can be copied, edited, and/or otherwise manipulated in the definition of a simulation and/or economic forecast of a tax policy of interest; d) a set of industry sectors and sub-sectors for which economic forecasts can be prepared; e) a set of macroeconomic variables and their values, which can be compared with a corresponding set of simulated variables generated by the software application program 108 for a particular tax policy change; and/or f) a set of elasticities (e.g., labor-leisure elasticity, product demand/supply elasticities, etc.) and their values, which can be varied to simulate the anticipated behavior of taxed entities in particular situations.

Report data and/or templates 142 can be stored in output files that are created, for example, for combinations of policies and tax types and which can display key parameters, results of a computation, simulation results, and/or changes in macroeconomic variables that can represent an effect of a tax policy change. The information provided by these reports can include, for example, increases and decreases in individual tax, business tax, property tax, consumer sales and/or excise tax; summaries of such taxes; tax receipts for a particular time period; changes in a variety of macroeconomic variables; and/or tax data for particular groups (e.g., industry sectors/sub-sectors, counties, etc.).

A mapping data structure 146 can refer to one or more tables or other data structures that can map data (e.g., computational/output fields) corresponding to a first tax policy (e.g., a baseline policy associated with a current tax law/policy) with corresponding data of a second tax policy (e.g., a hypothetical/proposed tax policy under evaluation). For example, the mapping data structure 146 can map an individual tax, which may be defined as an interest and dividends tax in a first tax policy, with a proposed individual tax, which may be defined as a modified income tax. In this manner, the mapping data structure 146 can be used by the software application program 108 to compare the two unique policies regardless of the differences in the names, positions, and/or components of particular fields in such policies. An exemplary set of fields that can be compared includes, for example, one or more classifier fields that can aggregate computed results into income or compensation brackets (ranges) and/or reference fields (e.g., taxable income, business enterprise tax, business profits tax, sales tax, excise tax, state and/or other valuation).

Policy organizational data, rules, and templates 140 can refer to data that is used to define tax policies and/or the rules that can affect the organization, display, and/or relationships of computational elements associated with such policies. Tax policies can be at least partially defined by one or more tax types (e.g., individual tax, business tax, property tax, sales tax, etc.), logical calculation groups (e.g., dividend tax, business profits tax, business enterprise tax, commercial property tax, residential owner-occupied tax, residential non-owner occupied tax, consumption tax, etc.), and/or computational elements (e.g., one or more references to database entries, constants used to compute parameters, brackets to identify ranges of values, references to data structures, mathematical expressions, etc.). The logical calculation groups can organize the computational elements in a manner that facilitates a user's definition and/or understanding of particular tax types in one or more policies under evaluation.

Another process that can be executed in a memory of the destination digital data processing device 110 can be an administrative process 148, which can refer to a set of instructions and other appropriate elements that can enable a digital data processing device 110 to monitor, control, and/or otherwise administer a tax policy analysis/simulation system. For example, the administrative process 148 can a) maintain and update configuration, runtime, and/or session data for one or more digital data processing devices 106, 110 and/or software application programs 104, 108 executing on such devices 106, 110; b) provide buffer management, multi-threaded services, and/or data structure management; c) provide initialization parameters to the digital data processing devices 106, 110 and/or software application programs 104, 108; d) manage groups of objects (e.g., groups of data elements stored on the digital data processing devices 106, 110 and/or stored or otherwise maintained in the database 134; groups of software application programs 104, 108; groups of users authorized to access software application programs 104, 108; groups of licenses, etc.); e) manage relationships between objects in response to messages communicated between one or more digital data processing devices 106, 110; f) provide one or more support services (e.g., encryption/decryption, compression, path routing, message parsing, message format manipulation, etc.) to the digital data processing devices 106, 110; and/or g) provide load balancing based on, for example, processor usage/availability, network usage/availability, memory usage/availability, software application program usage/availability, message length, and/or message volume. Those skilled in the art will recognize that, although the various processes and their functionality have been described with respect to particular embodiments, these processes and/or their functionality can be combined into a single process or into any combination of multiple processes. The processes can also be provided using a combination of built-in functions of one or more commercially-available software application programs and/or in combination with one or more custom-designed software modules.

In one illustrative operation, a processor 114 of the originating digital data processing device 106 can execute instructions associated with the software application program 102 (including, for example, runtime instructions specified, at least partially, by the user 102 and/or by another software application program, such as a batch-type program) that can instruct the processor 114 to at least partially control the operation of the graphics subsystem 122 in rendering and displaying a graphical user interface (including, for example, one or more menus, windows, and other visual objects) on the display device 126 that can support the definition of one or more tax policies, simulations, reports, and/or economic effects of interest.

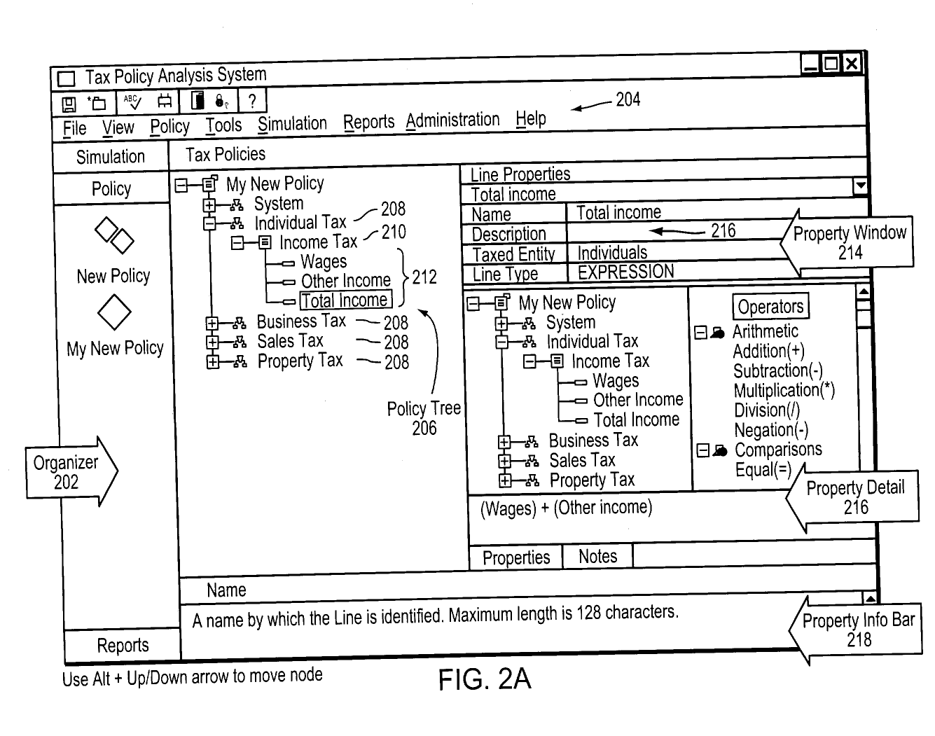

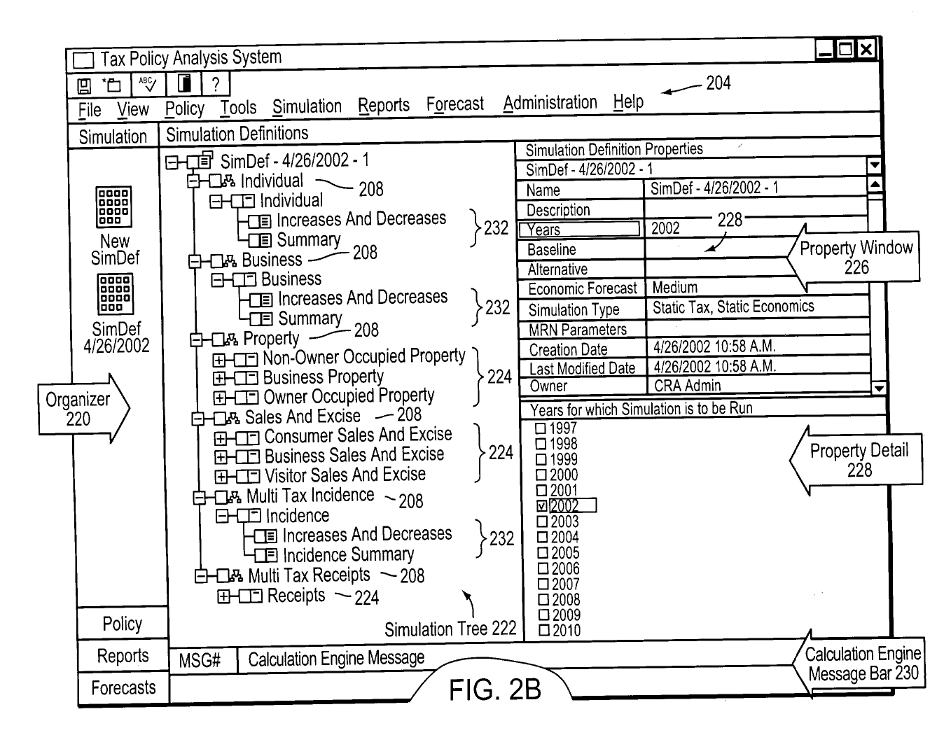

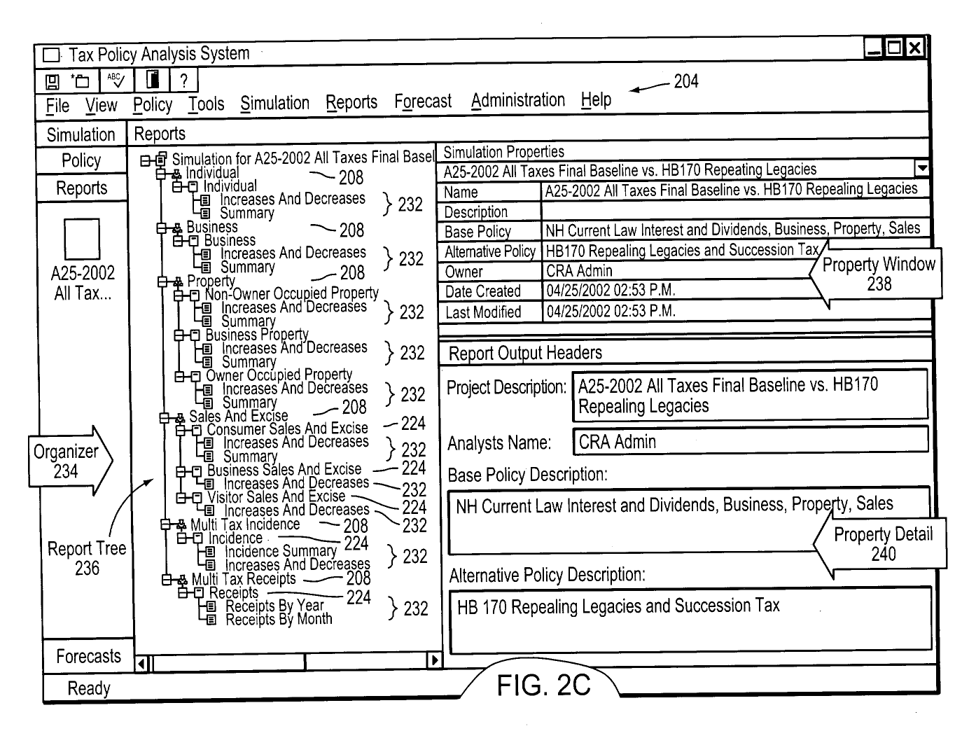

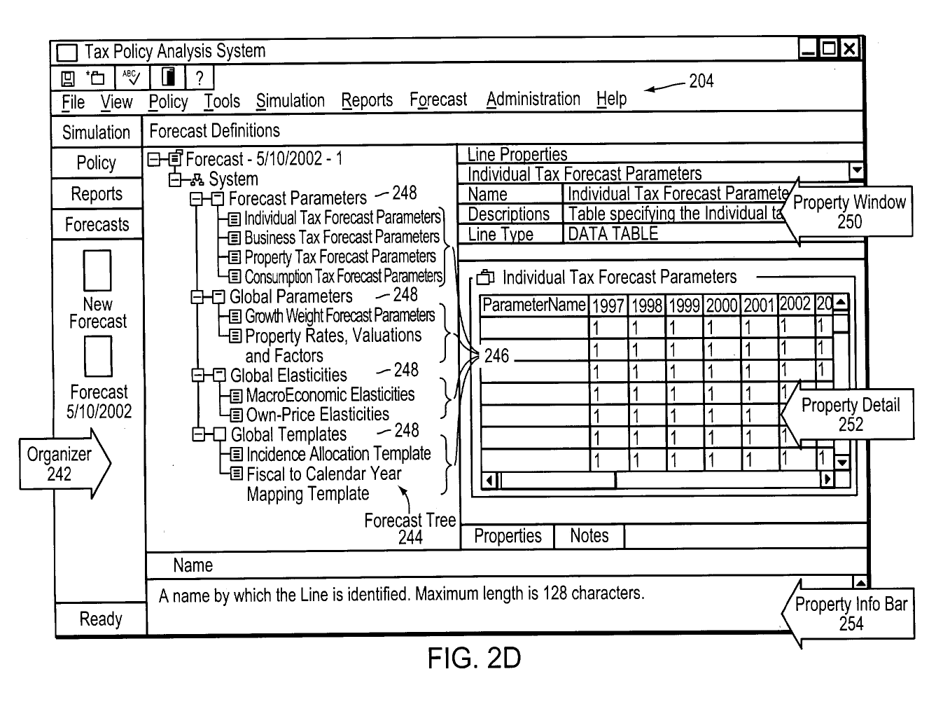

With reference to FIG. 2A, an exemplary illustration of a graphical user interface that can facilitate a definition of a tax policy can include 1) an organizer region 202 that can identify a name/label of one or more tax policies; 2) a menu and/or tool bar 204 that can be used to add, delete, and/or modify a tax policy and any attributes related thereto; 3) a policy tree 206 that can facilitate the organization and definition of a tax policy by providing a nested set of tax types 208, logical calculation groups 210, and/or computational elements 212; 4) a property window/region 214 that can be used to set attributes/properties 216 associated with a tax policy, including attributes associated with tax types 208, logical calculation groups 210, and/or computational elements 212; 5) a property detail window/region 216 that can be used to select context-sensitive expressions, datasource references, constants, and/or other values associated with computational elements 212 that define a tax policy (based on, for example, a selected tax type, logical calculation group, and/or computational element); and/or 6) a property information bar/region 218 that can provide context-sensitive help and/or serve as an online reference for a selected field. Those skilled in the art will recognize that although the tax types 208, logical calculation groups 210, and computational elements 212 are displayed as a hierarchical tree, any type of alternative representation (e.g., an influence diagram) that can facilitate the organization of data pertaining to a tax policy using a finite number of computational element types and which can be translated into software code that can be subsequently compiled and executed can suffice. A particular arrangement of tax types 208, logical calculation groups 210, and/or computational elements 212 displayed in a hierarchical tree and/or alternate graphical representation can be determined by a set of predetermined, but modifiable, rules (e.g., computational elements can not include nested logical calculation groups at a lower level of the hierarchical tree).

Similarly and with reference to FIG. 2B, an exemplary illustration of a graphical user interface that can facilitate a definition of a simulation for a tax policy can include 1) an organizer region 220 that can identify a name/label of one or more simulations; 2) a menu and/or tool bar 204 that can be used to add, delete, and/or modify a simulation and any attributes related thereto; 3) a simulation tree 222 that can represent a tax comparison as a nested set of taxes 208 and sub-taxes 224 that can define policies and sub-policies to be compared; 4) a property window/region 226 that can be used to set fields that describe a simulation and/or to set runtime parameters 228 (e.g., years, economic forecasts, simulation types, and/or policies to compare); 5) a property detail window/region 228 that can include variable selections (e.g., years to be simulated) and/or switch settings for a macro-economic forecast in a dynamic simulation; and/or 6) a message bar/region 230 that can display messages (e.g., progress messages, error messages, etc.) generated by a calculation process of the software application program 108 that may pertain to a computation of a tax policy. Those skilled in the art will recognize that although the taxes 208, sub-taxes 224 and report types 232 can be displayed as one or more hierarchical trees, any type of alternative representation (e.g., an influence diagram) that can facilitate the organization of data pertaining to a simulation of a tax policy can suffice. A particular arrangement of taxes 208, sub-taxes 224, and/or report types 232 displayed in a hierarchical tree and/or alternate graphical representation can be determined by a set of predetermined, but modifiable, rules (e.g., report types can not include nested sub-taxes at a lower level of the hierarchical tree).

With reference to FIG. 2C, an exemplary illustration of a graphical user interface that can facilitate understanding of a simulation output for a particular tax policy and simulation can include 1) an organizer region 234 that can identify a set of reports of one or more simulations and/or tax policies; 2) a menu and/or tool bar 204 that can be used to add, delete, and/or modify a report and any attributes related thereto; 3) a reports tree 236 that can represent a set of nested reports 232 associated with particular taxes 208 and/or sub-taxes 224; 4) a property window/region 238 that can contain a property/attribute that defines a tax 208 on which a report is based; and/or 5) a property detail window/region 240 that can include variable selections (e.g., years to be reported). Those skilled in the art will recognize that although the taxes 208, sub-taxes 224 and report types 232 can be displayed as one or more hierarchical trees, any type of alternative representation (e.g., an influence diagram) that can facilitate the organization of data pertaining to a report associated with a simulation of a tax policy can suffice. A particular arrangement of taxes 208, sub-taxes 224, and/or report types 232 displayed in a hierarchical tree and/or alternate graphical representation can be determined by a set of predetermined, but modifiable, rules (e.g., report types can not include nested sub-taxes at a lower level of the hierarchical tree).

With reference to FIG. 2D, an exemplary illustration of a graphical user interface that can facilitate economic forecasting (including the application of weights, factors, and macroeconomic parameters) of future year taxes can include 1) an organizer region 242 that can identify one or more forecasts associated with one or more tax policies and/or simulations; 2) a menu and/or tool bar 204 that can be used to add, delete, and/or modify a forecast and any attributes related thereto; 3) a forecast tree 244 that can represent a set of nested parameters (e.g., tax specific macro-economic parameters), factors, elasticities, and/or templates 246 associated with corresponding global parameters (e.g., system level access to appropriate weight and/or tax database records), elasticities (e.g., that may relate to dynamic or static economic simulations), and/or templates (e.g., corresponding to a default mapping table for tax incidence and receipts) 248 for a particular economic forecast; 4) a property window/region 250 that can contain data defining a forecast; 5) a property detail window/region 252 that can include values (e.g., in the form of tables) for tax specific parameters and global parameters; and/or 6) a property information bar/region 254 that can provide context-sensitive help and/or serve as an online reference for a selected field. Those skilled in the art will recognize that although the nested parameters, factors, elasticities, and/or templates 246, as well as, corresponding global parameters, elasticities, templates, and forecasts can be displayed as one or more hierarchical trees, any type of alternative representation (e.g., an influence diagram) that can facilitate the organization of data pertaining to a forecast associated with a tax policy can suffice. A particular arrangement of nested parameters, factors, elasticities, and/or templates 246, as well as, corresponding global parameter, elasticities, templates, and forecasts displayed in a hierarchical tree and/or alternate graphical representation can be determined by a set of predetermined, but modifiable, rules (e.g., macro-economic elasticities can not include nested global elasticities at a lower level of the hierarchical tree).

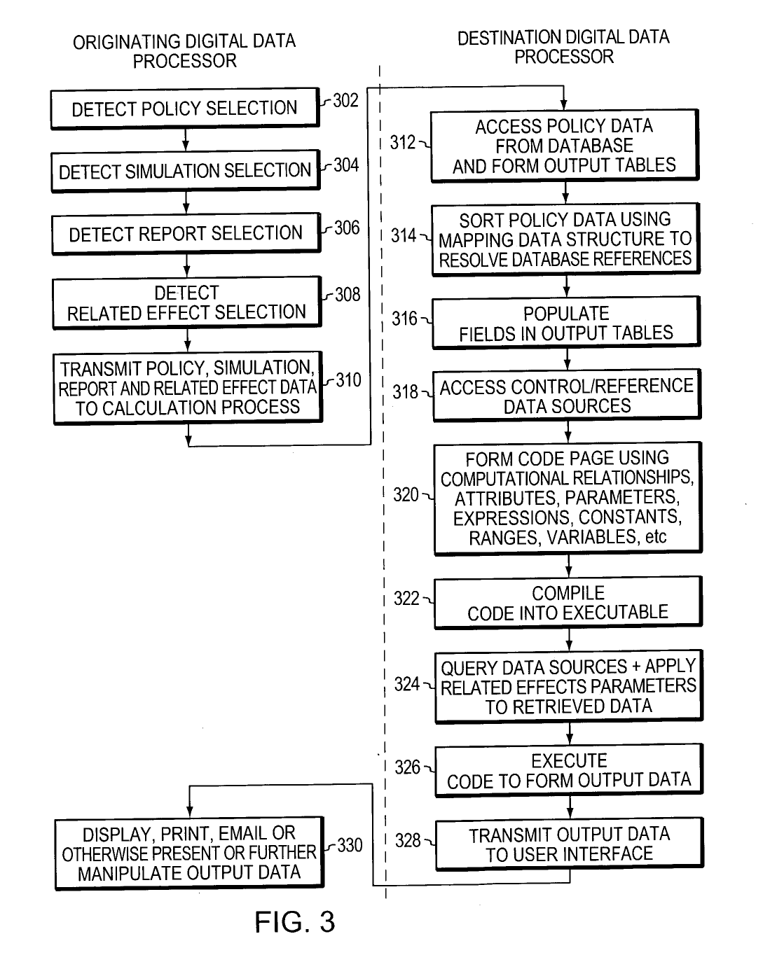

In one illustrative operation and with reference to FIGS. 1 and 3, the software application program 104 executing within a memory 118 of the originating digital data processing device 106 can detect a user's selection of a particular tax policy (such as the exemplary tax policy illustrated in FIG. 2A) (302) by, for example, receiving an indication of such selection from the I/O subsystem 124 that captured a mouse click, keyboard entry, and/or other input event initiated by the user 102. In response to the user selection of a tax policy, the software application program 104 can access a set of tax types 208 (e.g., individual tax, business tax, sales tax, and/or property tax) supported by the application program 104 and can instruct the graphics subsystem 122 (via the processor 114) to display the supported tax types in a graphical user interface (as shown, for example, in FIG. 2A). The user 102 can then initiate another input event corresponding to a selection of a particular tax type from the set of supported tax types. The software application program 104 can detect the user's selection of the tax type and can responsively display one or more logical calculation groups 210 and/or computational elements 212 within a hierarchical tree 206 in the graphical user interface. Similar sequences of input events and detections by the software application program 104 can enable the user 102 to select particular logical calculation groups 210 and/or computational elements 212 and to specify particular attributes and properties (such as, for example, the data shown presented within the property window 214 and/or property detail window 216 of FIG. 2A) that define a tax policy of interest.

In one embodiment, a set of available tax types 208 can be presented to the user 102 upon a user's selection of a particular tax policy, one or more logical calculation groups 210 corresponding to particular tax types 208 can be displayed to the user 102 upon the user's selection of a specific tax type 208, and/or one or more computational elements 212 corresponding to one or more of the logical calculation groups 210 can be displayed to the user 102 upon the user's selection of a specific logical calculation group 210. Similarly, the particular attributes and properties displayed in a property window 214 (FIG. 2A) and a property detail window 216 can be based on prior selections made by the user 102 during the definition of the tax policy of interest. In this manner, the software application program 104 can display information pertinent to a particular policy definition, rather than provide a more extensive, and thus confusing, array of data/available selections that may apply to other types of supported policies.

Similarly, the software application program 104 can detect a user's selection of a particular simulation (such as the exemplary simulation illustrated in FIG. 2B) (304). In response to the user selection of a simulation, the software application program 104 can access a set of tax types 208, sub-tax types 224, and/or report types 232 (such as the exemplary embodiments shown in FIG. 2B) supported by the application program 104 and can instruct the graphics subsystem 122 to display the supported tax, sub-tax, and/or report types in a graphical user interface (as shown, for example, in FIG. 2B). As described above in connection with tax policies, the user 102 can specify particular attributes, properties, parameters, variables, switch settings and/or other data associated with the selected policy (such as, for example, the data shown within the property window 226 and/or property detail window 228 of FIG. 2B) that define a simulation of interest.

In one embodiment, a set of available tax types 208 can be presented to the user 102 upon a user's selection of a particular simulation, one or more sub-tax types 224 and/or report types 232 corresponding to a particular tax type 208 can be displayed to the user 102 upon the user's selection of a specific tax type 208, and/or one or more report types 232 corresponding to one or more of the sub-tax types 224 can be displayed to the user 102 upon the user's selection of a specific sub-tax 224. Similarly, the particular attributes and properties displayed in a property window 226 (FIG. 2B) and a property detail window 228 can be based on prior selections made by the user 102 during the definition of the simulation of interest. In this manner, the software application program 104 can display information pertinent to a particular simulation definition, rather than provide a more extensive, and thus confusing, array of data/available selections that may apply to other types of supported simulations.

The software application program 104 can also provide a set of nested reports corresponding to an output of a simulation for one or more tax and/or sub-tax types of a tax policy and can detect a user's selection of a particular report (such as the exemplary set of reports illustrated in FIG. 2C) (306). Further, the software application program 104 can detect a user's selection of a particular economic forecast and/or parameters associated with a particular tax policy and simulation (such as those provided in the exemplary display illustrated in FIG. 2D) (308). In response to the user selection of forecast parameters, global parameters, global elasticities, and/or global templates 248, the software application program 104 can access a set of corresponding parameters, factors, elasticities, and/or templates 246 that can define a particular forecast of interest (such as the exemplary embodiments shown in FIG. 2D) and can instruct the graphics subsystem 122 to display these elements in a graphical user interface (as shown, for example, in FIG. 2D). As described above, the user 102 can specify particular attributes and/or other values pertaining to a forecast of interest (such as, for example, the attributes/values shown within the property window 250 and/or property detail window 252 of FIG. 2D).

With continuing reference to FIGS. 1 and 3, the software application program 104 can instruct the network connection process 128 of the originating digital data processing device 106 to transmit the attributes, parameters, and/or other data associated with the policy, simulation, report, and/or related forecast effects 148-154 selected by the user 102 to a calculation process or other software process associated with the software application program 108 executing on the destination digital data processing device 110 (310) by, for example, encoding, encrypting, and/or compressing the selected data 148-152 into a stream of data packets that can be transmitted between the networking subsystems 120 of such digital data processing devices 106, 110. The network connection process 130 executing on the destination digital data processing device can receive, decompress, decrypt, and/or decode the information contained in the data packets and can store such elements in a memory accessible to the software application program 108.

The software application program 108 can access the stored elements 148-152 to obtain information that can enable the program 108 to issue a query to a database 134 to access related policy data, rules, and/or templates 140 that can be used in forming one or more output tables or other data structures, which can be used in reporting the results of the selected policy, simulation, and/or forecast 148, 150, 154 in accordance with the selected report attributes 152 (312). A mapping data structure 146 can be accessed to identify database mapping relationships 156 that can resolve differences between the selected policy data 148 that may be represented as hierarchical tree data 158 and corresponding database policy data 140 (314). The software application program 108 can subsequently use the resolved data to populate fields in the output tables (316). Control/reference data sources 136 can also be accessed to obtain relevant data for supporting the simulation of the selected tax policy (318). The software application program 108 can apply computational relationships 160 to the selected data 148-154, resolved data, and/or control/reference data to form a code page (e.g., one or more modules of software code) (320) that can be compiled into an executable (322), function library, and/or component containing executable code that can be called by the executable or other executing controller (e.g., operating system service, COM+ service component, etc.). Prior to executing the software code to form output data (326), the software application program 108 can query data sources and apply forecast and other related economic effects parameters to the data retrieved from the database 134 (324). Once the code is executed to form the output data 162 (326), the software application program 108 can instruct the network connection process 130 to transmit the output data to the software application program 104 of the originating digital data processing device 106 (328). Upon receiving the transmitted output data 162, the software application program 104 can display the received data in the graphical user interface, print it out in hard copy, mail it electronically to one or more email users, and/or otherwise manipulate, distribute, and/or display the output data (330).

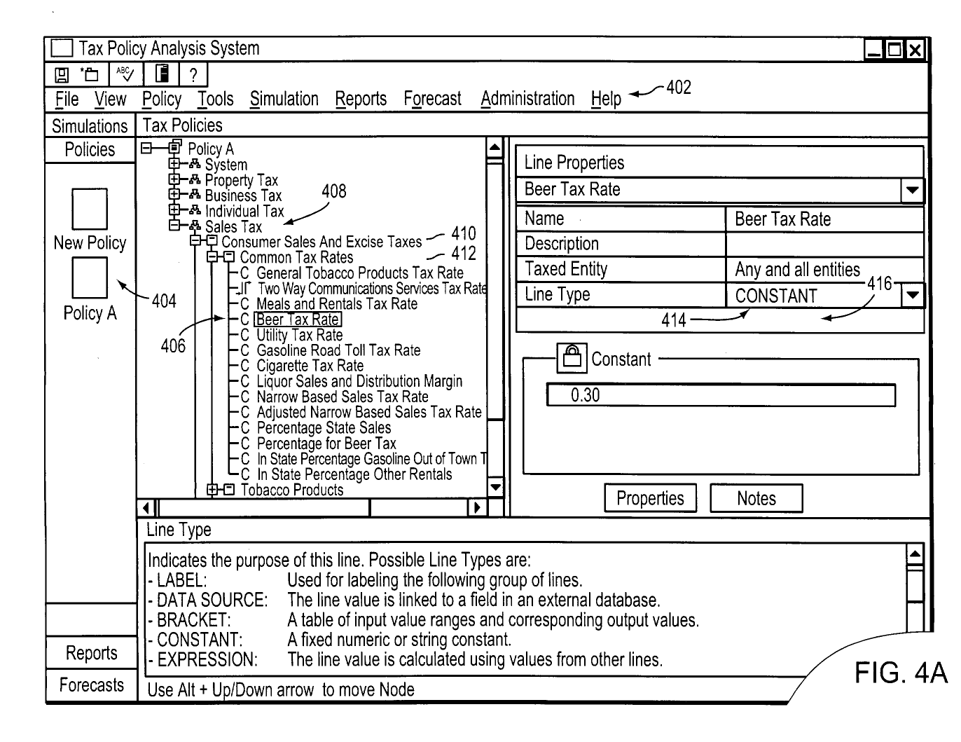

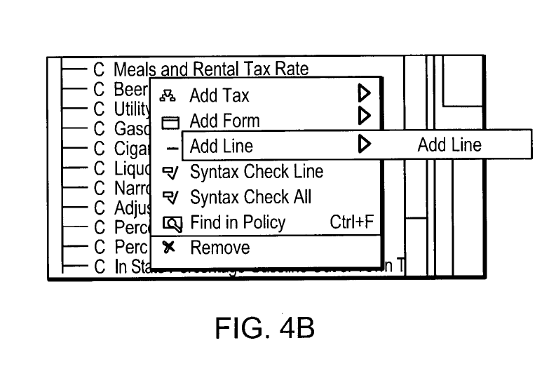

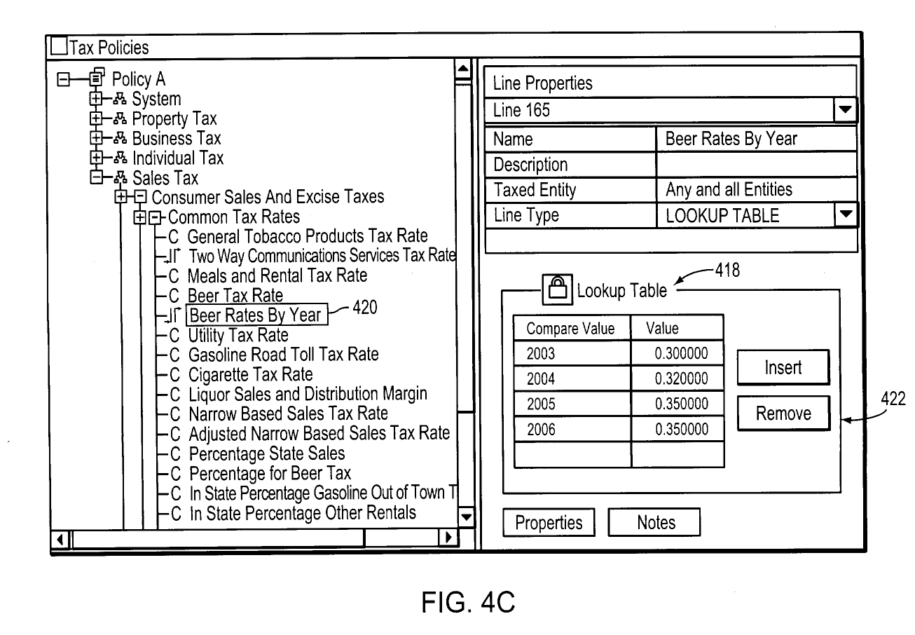

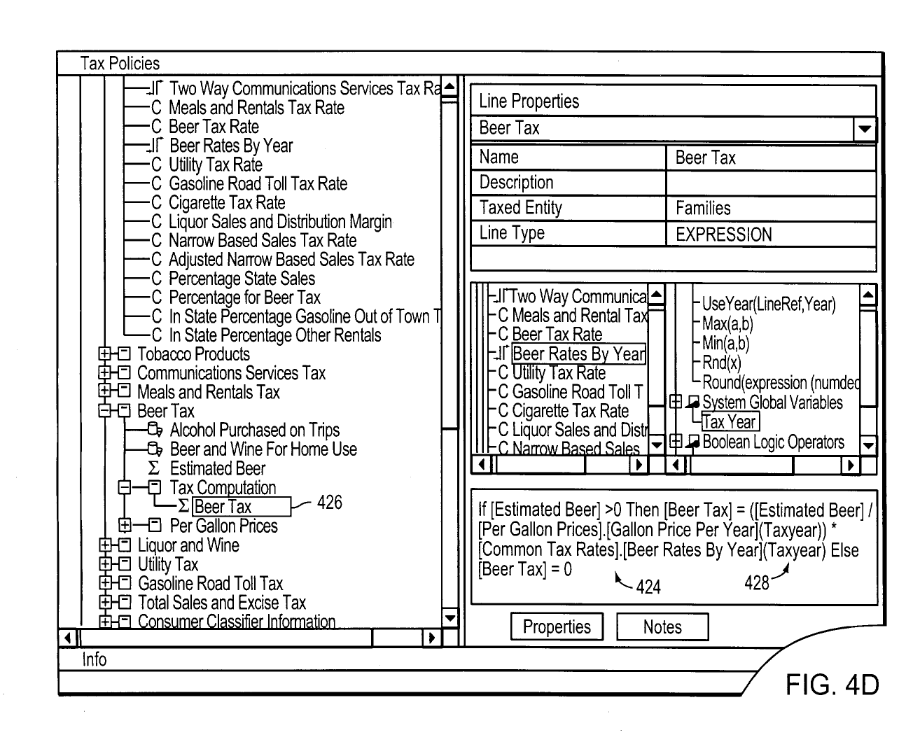

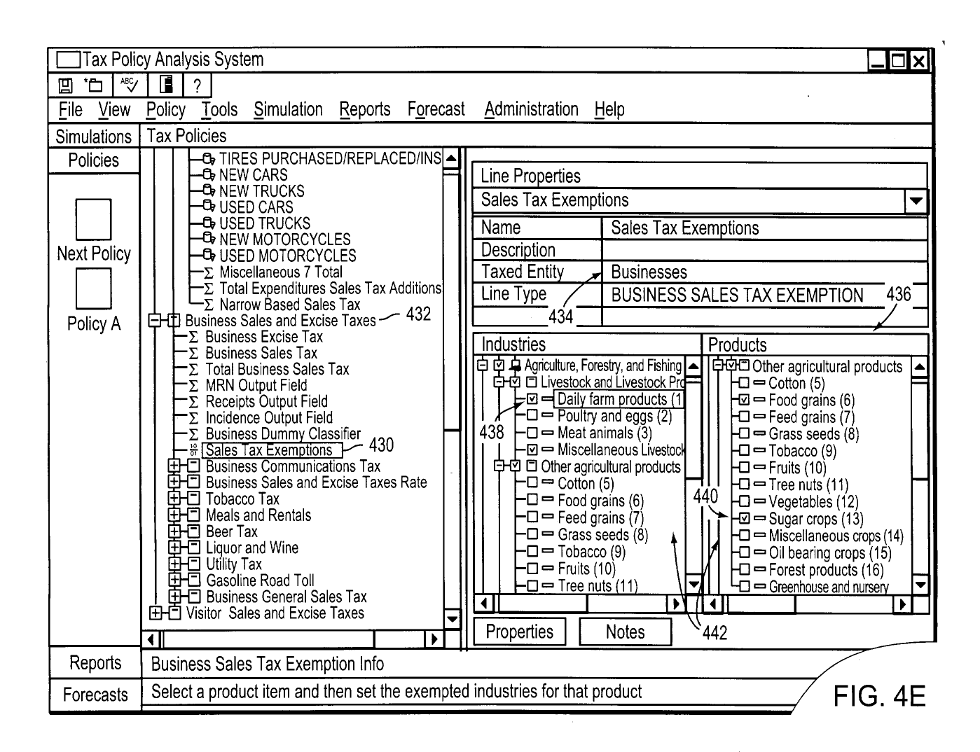

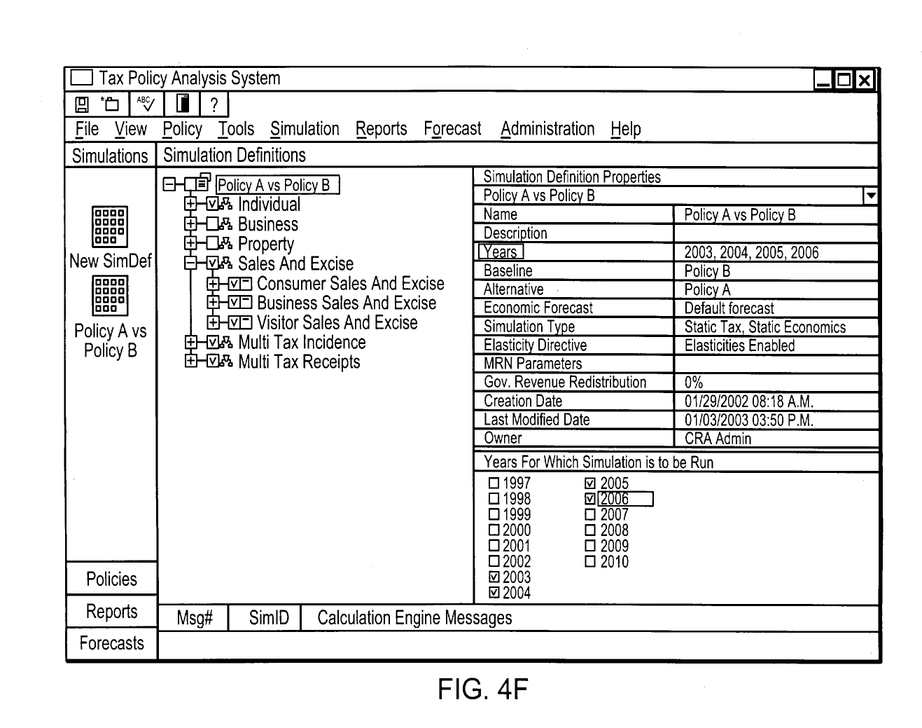

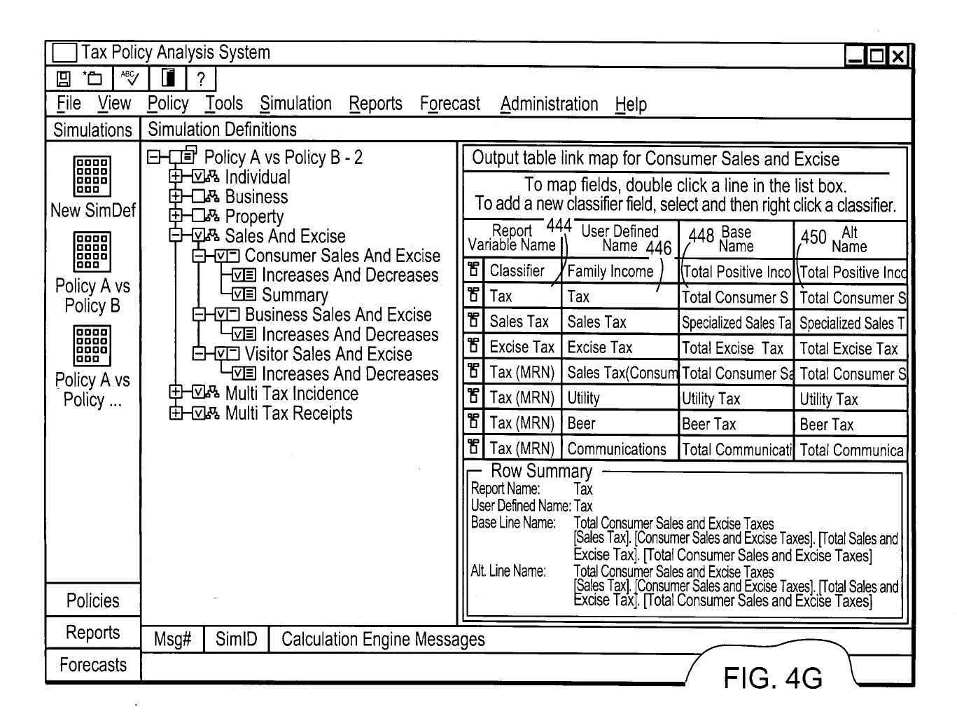

By way of non-limiting example and with reference to FIGS. 4A-4D, a user 102, desiring to investigate potential economic effects of changing a previously constant tax rate on beer to a variable tax rate over a range of years, can define a hypothetical tax policy by 1) copying an existing tax policy corresponding to a current tax law (named, for example, Policy B) by, for example, selecting “Policy” from the menu bar 402 and specifying that Policy B is to be copied and renamed “Policy A” 404, 2) selecting a “Beer Tax Rate” computational element 406 from the nested set of tax types (Sales Tax 408), logical calculation groups (“Consumer Sales and Excise Taxes” 410 and “Common Tax Rates” 412), and computational elements of Policy A, 3) modifying a “Line Type” attribute 414 of the Beer Tax Rate computational element 406 displayed in a property window 416 that was previously set to a constant value (for Policy B) to a lookup table 418 (FIG. 4C) by adding the line/computational element, entitled “Beer Rates by Year” 420 as shown in FIGS. 4B and 4C and specifying a set of values for the “Beer Rates by Year” lookup table 418 in the property detail window 422, and 4) modifying a computational expression 424 of a “Beer Tax” computational element 426 as shown in FIG. 4D to replace a reference of the constant Beer Tax Rate of Policy B with a reference to the “Beer Rates by Year” look up table 418 and using a predefined system global variable, entitled “Tax Year” 428 to indicate the variable year.

The hypothetical tax policy, Policy A, can also include one or more additional hypothetical tax policy changes. For example and with reference to FIG. 4E, if the user 102 desires to concurrently investigate the economic effects of exempting sugar crops used in dairy farm industries from a business sales tax, the user 102 can also 1) select an existing (or add a new computational element entitled) “Sales Tax Exemptions” computational element 430 associated with a “Business Sales and Excise Taxes” logical calculation group 432 of Policy A 404, 2) specify that a “Taxed Entity” attribute 434, displayed in the property window 436, is set to “Businesses,” 3) select a “Dairy farm products” checkbox 438 and a “Sugar crops” checkbox 440 displayed in the associated “Industries” and “Products” property detail windows 440 to exempt the sugar crops used in dairy farm products from a business sales tax, and 4) check the syntax of expression lines associated with Policy A to ensure that any syntax errors are detected and corrected.

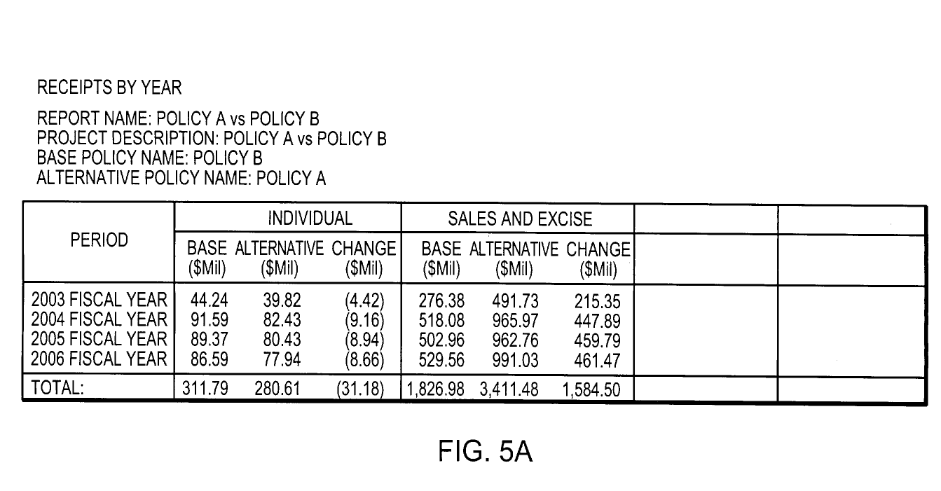

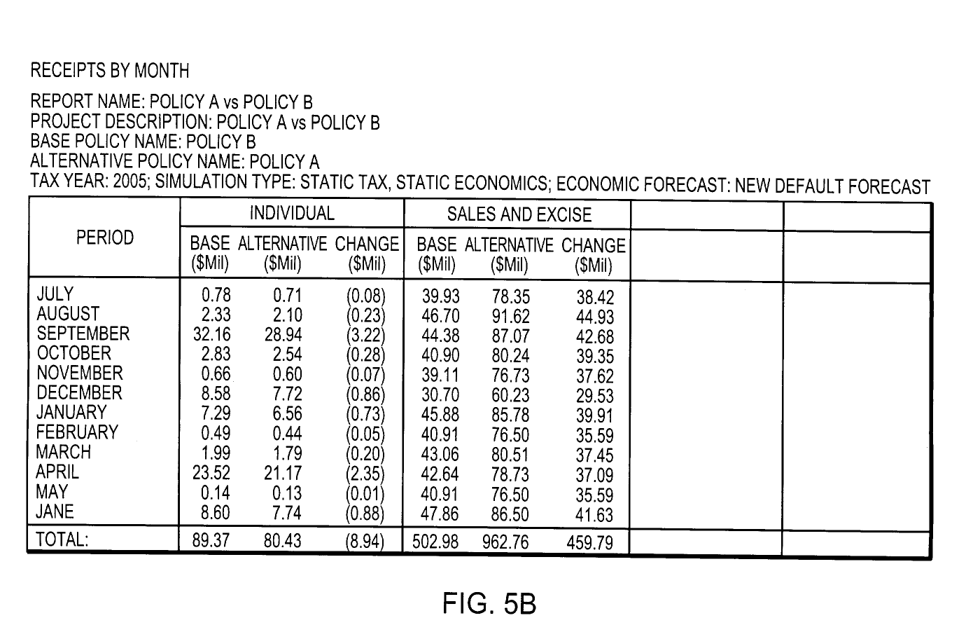

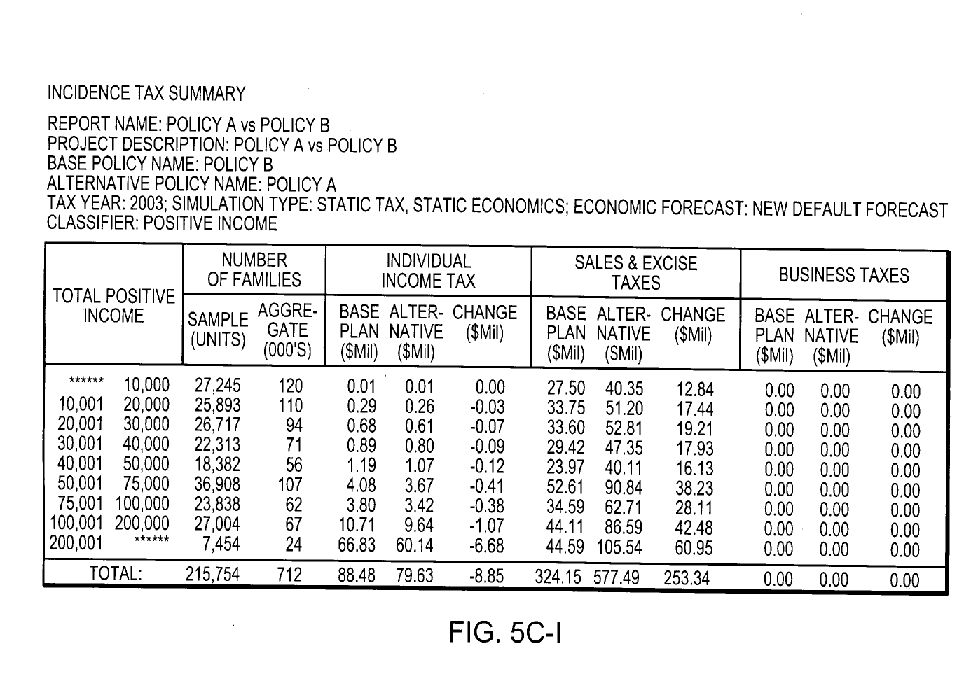

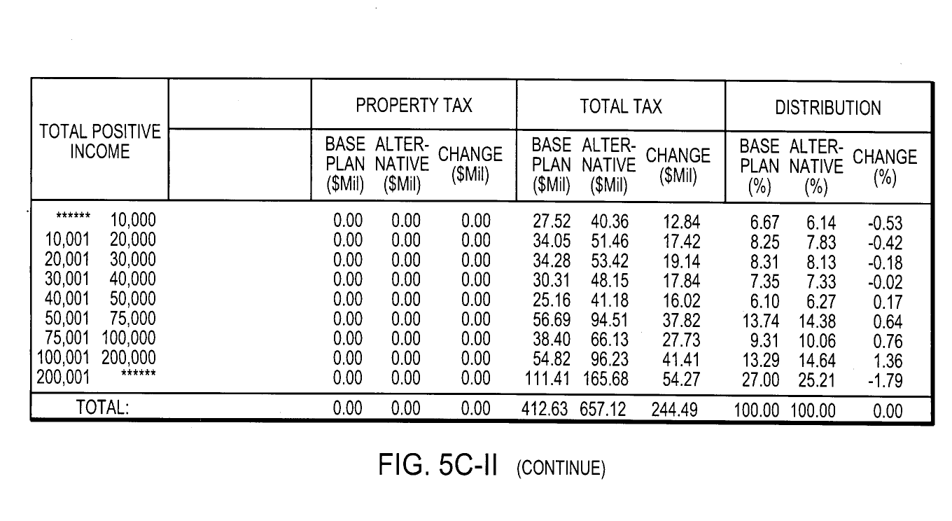

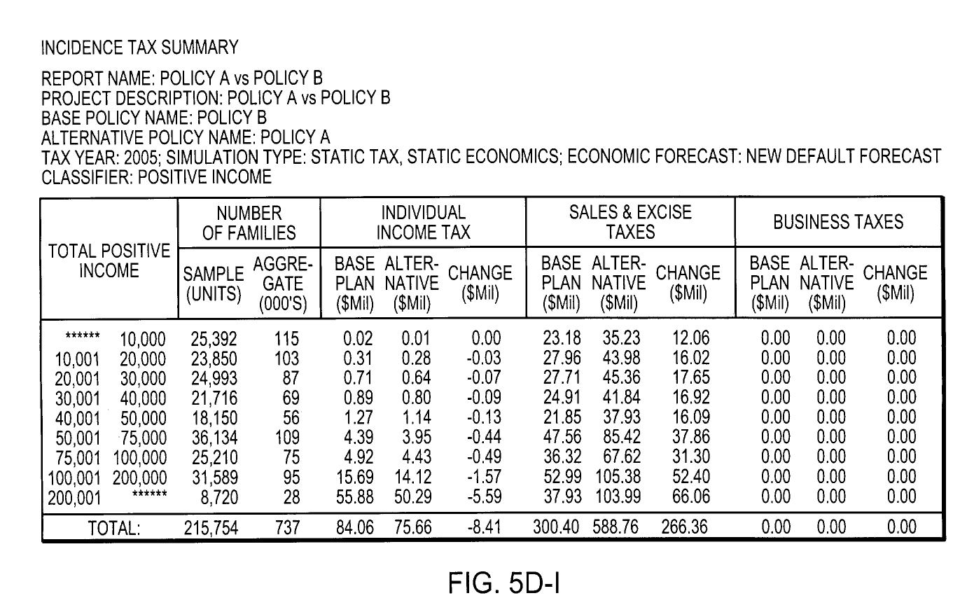

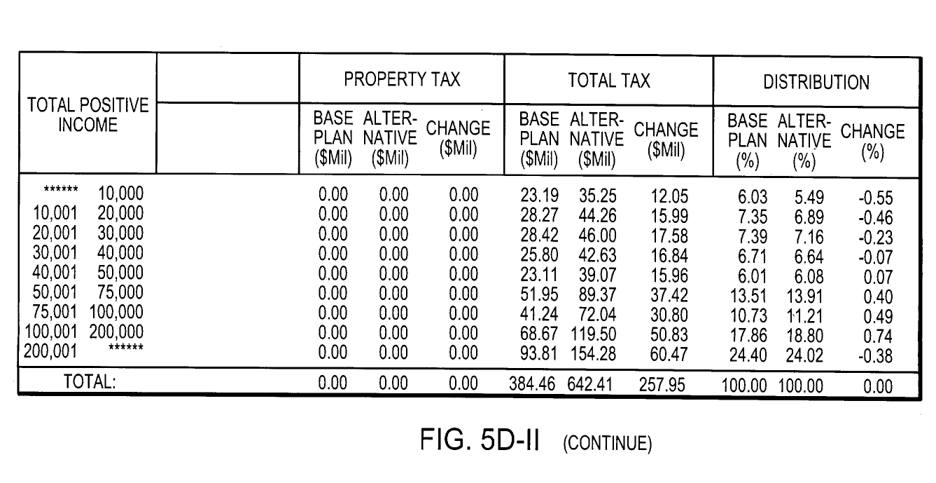

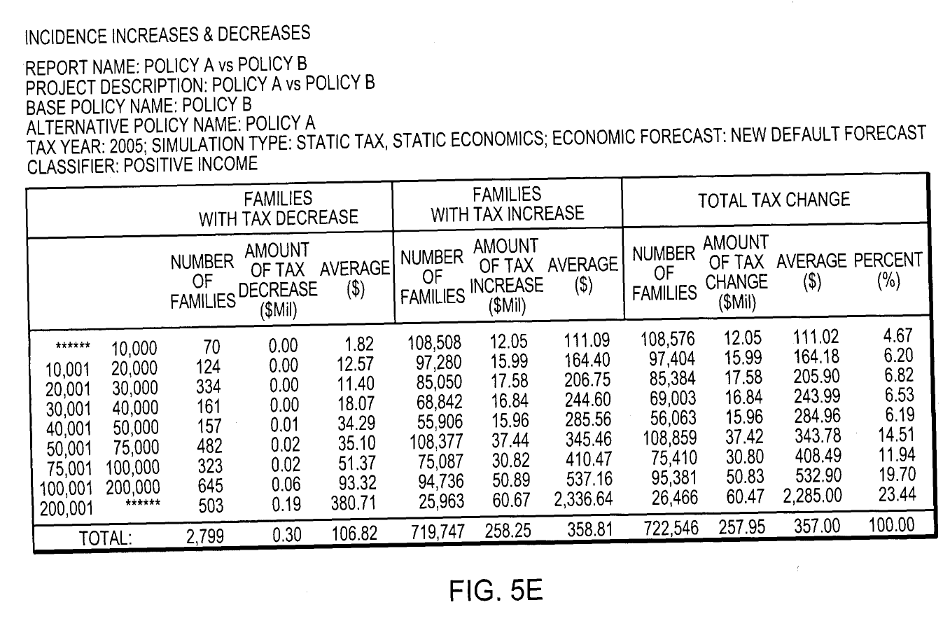

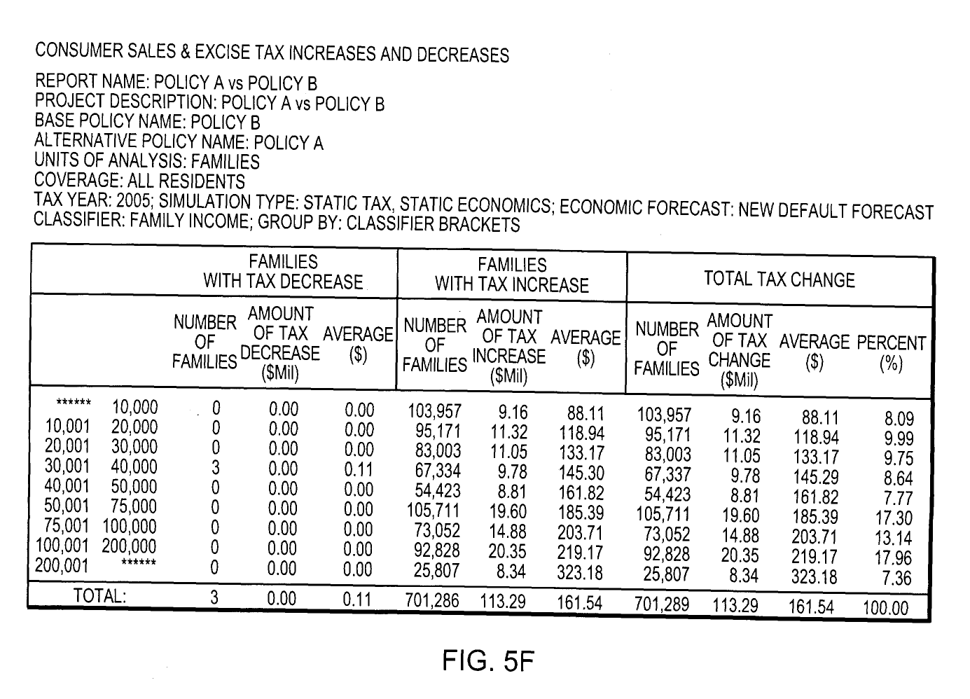

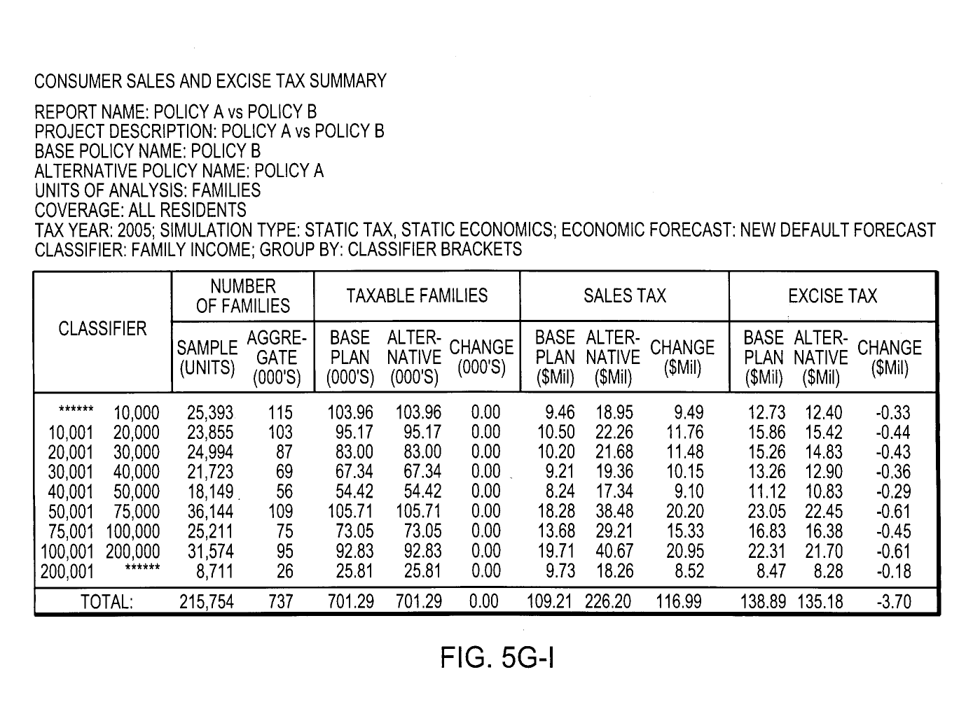

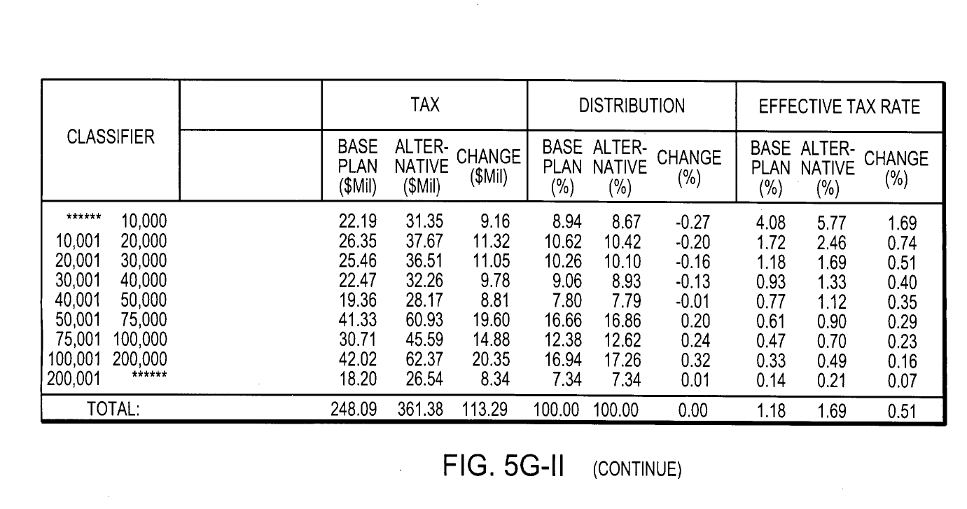

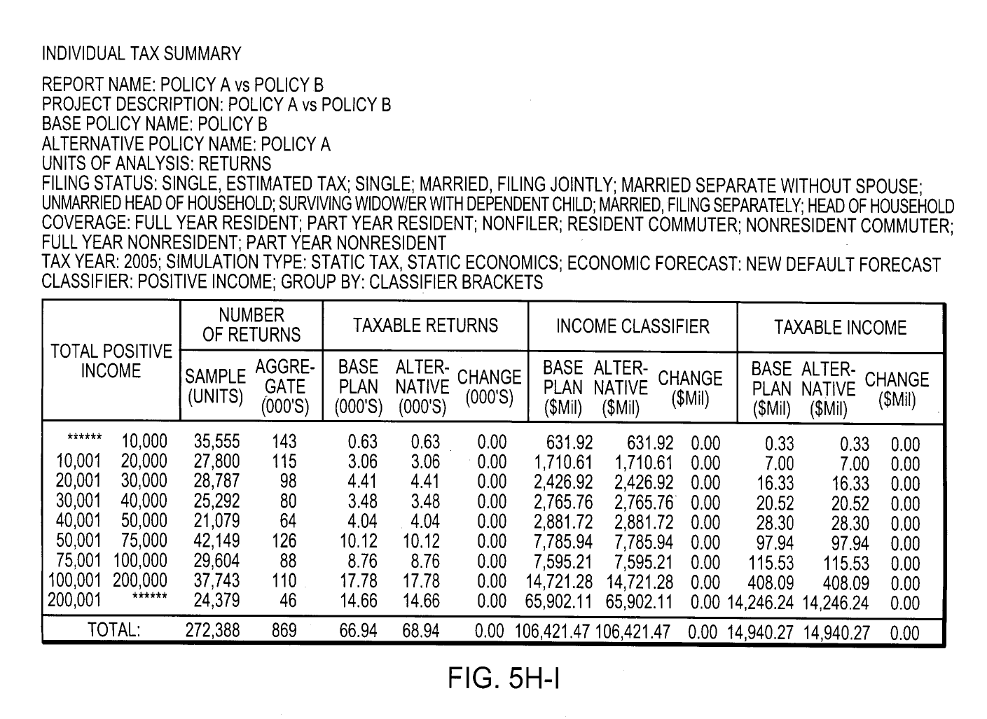

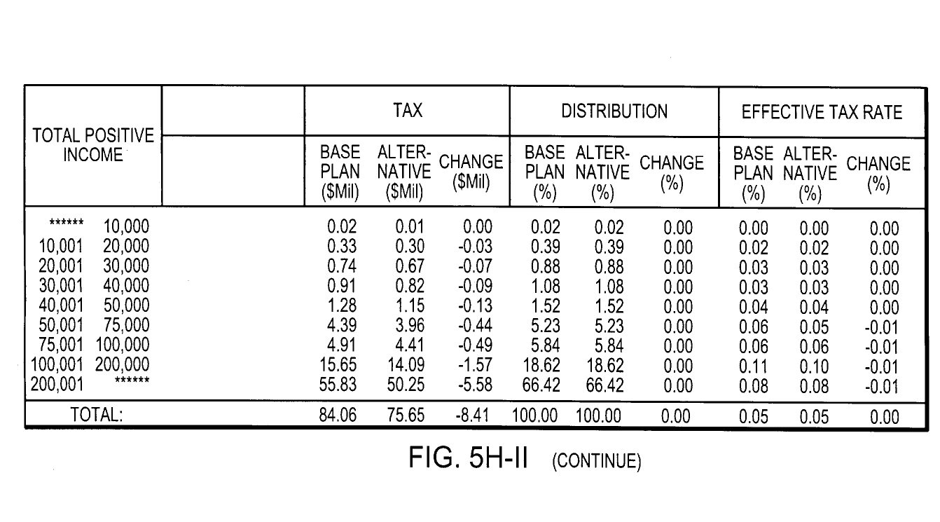

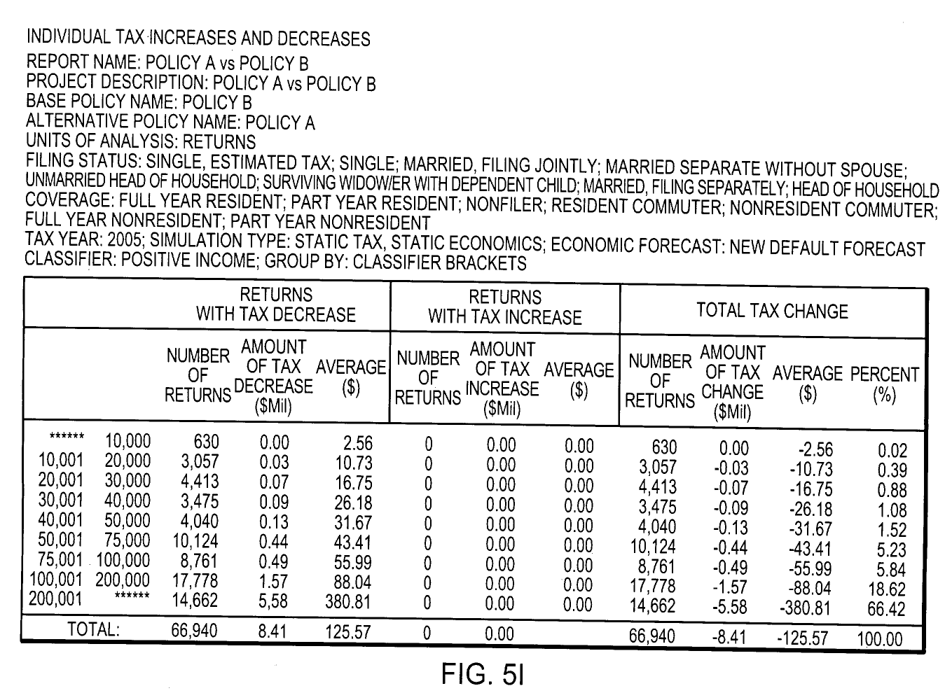

After defining the hypothetical tax policy changes for Policy A and with reference to FIGS. 4F and 4G, the user can define the properties of a desired simulation by selecting the policies to be compared (e.g., Policy A and Policy B) as well as the desired forecast type and range of years that the user is interested in evaluating. The definition of the simulation can involve mapping fields in the simulation output reports to output fields associated with the policies. Mapping can also be performed to select/specify a subset of the computational elements needed to produce the desired reports from a larger set of available computational elements. Although this mapping function can be performed automatically, it can also be performed manually. An unmapped computational element corresponding to a particular named variable in a report of interest can be linked to a particular computational element of Policy A or Policy B. For example and with reference to FIG. 4G, an internal report variable, named “Tax” 444 can be mapped to a user defined variable, also named “Tax” 446 and can be displayed along with the names of corresponding computational elements for Policy B and Policy A 448, 450. Although this illustrative example has identical names for the report variable name/user defined names 444, 46 and identical names for the computational elements of Policies B and A 448, 450, other embodiments can use differing names. Once the desired policy and simulation have been defined, the simulation can be performed as previously described to generate reports with output fields that can identify anticipated economic effects of identified tax policy changes. An exemplary set of reports that can be produced for this illustrative simulation are provided in FIGS. 5A-5I.

Although the disclosed technology has been described with reference to specific embodiments, it is not intended that such details should be regarded as limitations upon the scope of the invention, except as and to the extent that they are included in the accompanying claims.

What is claimed is:

1. A method of determining an economic effect of a tax policy, the method comprising:
providing a tax type, a logical calculation group, and a computational element at least partially defining a first tax policy;
associating the tax type, logical calculation group, and computational element to provide a hierarchical tree associated with the first tax policy;
comparing data associated with the computational element in the hierarchical tree with data associated with a corresponding computational element of a second tax policy; and
computing at least one economic effect of the first tax policy based at least partially on the compared data.

2. The method of claim 1 further comprising:
detecting a selection of the tax type of the first tax policy, the selected tax type being displayable as part of the hierarchical tree displayed in a graphical user interface;
detecting a selection of the logical calculation group, the logical calculation group being displayable in a level of the hierarchical tree lower than that of the selected tax type and in response to the selection of the tax type and;
detecting a selection of the computational element, the computational element being displayable in a level of the hierarchical tree lower than that of the selected logical calculation group and in response to the selection of the logical calculation group.

3. The method of claim 1 wherein the tax type corresponds to at least one of an individual tax, a business tax, a property tax, and a sales tax.

4. The method of claim 1 wherein the logical calculation group corresponds to at least one of a dividend tax, a business profits tax, a business enterprise tax, a commercial property tax, a residential owner occupied tax, a residential non-owner occupied tax, and a consumption tax.

5. The method of claim 1 wherein the computational element corresponds to at least one of a label to identify other computational elements, a reference to a particular database entry, a constant used to compute a parameter, a bracket to identify a range of values, a reference to a data structure, and a mathematical expression.

6. The method of claim 1 wherein the first tax policy corresponds to a proposed tax law change and the second tax policy corresponds to a current tax law.

7. The method of claim 1 wherein the economic effect corresponds to a change in a macroeconomic variable.

8. A method of determining an economic effect of a tax policy, the method comprising:
detecting a selection of a tax type associated with a first tax policy, the selected tax type being displayable within a graphical user interface;
detecting a selection of a logical calculation group associated with the selected tax type, the selected logical calculation group being displayable in a lower level of a hierarchical tree relative to the selected tax type;
detecting a selection of a computational element associated with the selected logical calculation group and defining at least part of the first tax policy, the selected computational element being displayable in a level of the hierarchical tree below that of the selected logical calculation group;
comparing data associated with the selected computational element in the hierarchical tree with data associated with a corresponding computational element of a second tax policy; and
computing at least one economic effect of the first tax policy based at least partially on the compared data.

9. A method of determining an economic effect of a tax policy, the method comprising:
organizing a first tax policy as a hierarchical tree of tax types, logical calculation groups, and computational elements, the tax policy being at least partially defined by modifying an attribute associated with at least one of the tax types, logical calculation groups, and computational elements;
comparing data associated with at least one computational element in the hierarchical tree of the first tax policy with data associated with a corresponding computational element of a second tax policy; and
computing at least one economic effect of the first tax policy based at least partially on the compared data.
